(19) United States
(12) Patent Application Publication
(10) Pub. No.: US 2018/0370708 A1
(43) Pub. Date: Dec. 27, 2018

(54) EJECTABLE CONTAINER

(71) Applicant: Dominic Anthony Pizza, Jr., Westborough, MA (US)

(72) Inventor: Dominic Anthony Pizza, Jr., Westborough, MA (US)

(21) Appl. No.: 15/634,430

(22) Filed: Jun. 27, 2017

(51) Int. Cl. B65D 81/02; B64D 45/00; B63B 45/00; G01S 19/17

(52) U.S. Cl. CPC B65D 81/02; B64D 45/00; B63B 2201/26; G01S 19/17; B64D 2045/0065; B63B 45/00

(57) ABSTRACT

An ejectable container that includes: six sides formed as a cuboid; an ejection mechanism; a battery within the container; a GPS locator; and fire proof materials for structural components.

### BACKGROUND OF THE INVENTION

### Field of Invention

The present invention relates to a data storage recorder container for implementation on a plane or ship.

### Description of Related Art

It is well known planes and ships contain various types of data recorders to establish location and conditions at the time of an accident. These data recorders must be found after an accident for investigators to determine cause of the accident and to pursue suitable safety measures for prevention. Sometimes it is difficult to locate a black box that is typically used to store data in certain planes and ships. As a result, it would be advantageous to have a more dynamic and suitable device that could be retrieved as necessary.

### SUMMARY OF THE INVENTION

The present invention relates to an ejectable container that includes: six sides formed as a cuboid; an ejection mechanism; a battery within the container; a GPS locator; and fire proof materials for structural components.

### BRIEF DESCRIPTION OF DRAWINGS

FIG. 1 depicts a data storage container in accordance with the present invention.

### DETAILED DESCRIPTION

The present invention relates to a data storage container that is ejectable from a plane or ship that stores data for retrieval after an accident or a fire on a passenger vehicle such as a plane or a ship. The data storage device according to present invention is a 6-sided cube ejected upon impact or in high temperature conditions. The materials used to create this device are highly fireproof and explosion proof. The device ejects upon impact or upon occurrence of extreme temperatures. This ejection allows the data storage device to preserve data stored on memory within the device. The device includes a processor and suitable memory to store navigation data related to the plane or ship. This navigation data may be retrieved due to the highly fireproof and impact resistant container that stores the processor and memory. In addition to suitable computing power within the device, a GPS locater is also installed in the device providing immediate transmission upon ejection from a plane or ship. This ensures that the device is tracked immediately and therefore easily retrieved by emergency personnel.

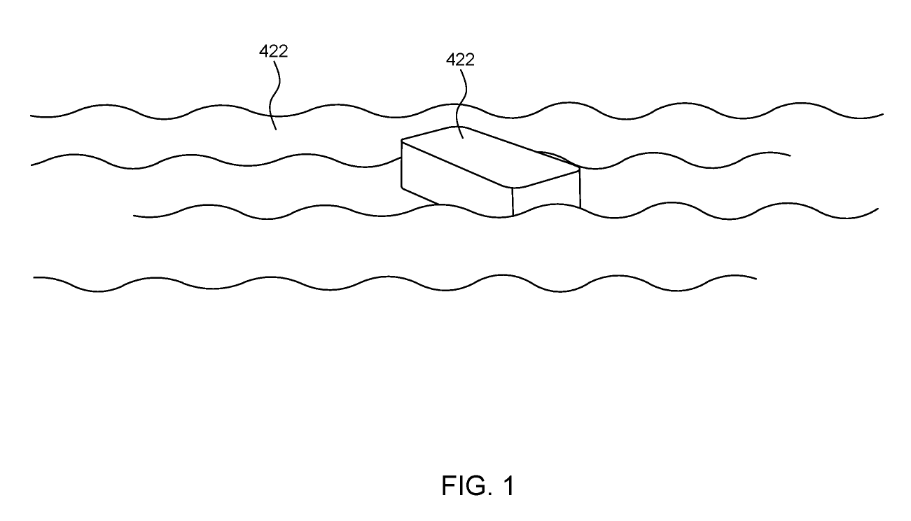

FIG. 1 depicts use of a storage device 30 which is an ejectable container that is shown floating in a body of water 20. In addition to having extreme fireproof capabilities the device also has sufficient buoyancy capacity to float on a body of water. Once ejected the GPS signal is transmitted automatically providing a locating system for first responders.

Exemplary materials used to create the storage device include a magnesium alloy for the exterior having a matrix composite of 0.92 g/cc. Further dye is injected over the surface of the container upon ejection from the plane or ship. The systems within the container are powered through a small but effective battery that has a sufficient life span to ensure operation of the electronics and in particular the GPS feature related to the device. Other features of the device include memory and a processor where the memory stores and records vital flight or navigational data that is easily retrievable from the device.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An ejectable container comprising:
six sides formed as a cuboid;
an ejection mechanism
a battery within the container;
a GPS locator; and
fire proof materials for structural components.
